(19) United States
(12) Patent Application Publication
(10) Pub. No.: US 2020/0372637 A1
(43) Pub. Date: Nov. 26, 2020

(54) SYSTEM METHOD AND COMPUTER-ACCESSIBLE MEDIUM FOR CLASSIFYING TISSUE USING AT LEAST ONE CONVOLUTIONAL NEURAL NETWORK

(71) Applicant: THE TRUSTEES OF COLUMBIA UNIVERSITY IN THE CITY OF NEW YORK, hEW YORK, NY (US)

(72) Inventor: RICHARD HA, White Plains, NY (US)

(21) Appl. No.: 16/766,269

(22) PCT Filed: Nov. 23, 2018
(86) PCT No.: PCT/US2018/062395

§ 371 Date: May 21, 2020

Related U.S. Application Data
(60) Provisional application No. 62/589,924, filed on Nov. 22, 2017.

(51) Int. Cl. G06T 7/00; G06T 7/11

(52) U.S. Cl. CPC G06T 7/0012; G06T 7/11; G06T 2207/20084; G06T 2207/30068; G06T 2207/20081; G06T 2207/10088

(57) ABSTRACT

An exemplary system, method and computer-accessible medium for classifying a tissue(s) of a patient(s) can include, for example, receiving an image(s) of an internal portion(s) of a breast of the patient(s), and automatically classifying the tissue(s) of the breast by applying a neural(s) network to the image(s). The tissue(s) can include a lymph node(s). The lymph node(s) can be classified as a cancerous tissue or a non-cancerous tissue. The tissue(s) can be classified as a fibroglandular tissue or a background parenchymal enhancement tissue. The tissue(s) can be classified as a cancer molecular subtype. The image(s) can be is a magnetic resonance image.

### CROSS-REFERENCE TO RELATED APPLICATION(S)

This application relates to and claims priority from U.S. Patent Application No. 62/589,924, filed on Nov. 22, 2017, the entire disclosure of which is incorporated herein by reference.

### FIELD OF THE DISCLOSURE

The present disclosure relates generally to a classification of information regarding breasts and breast tissue, and more specifically, to exemplary embodiments of systems, methods and computer-accessible medium for classifying tissue using at least one convolutional neural network.

### BACKGROUND INFORMATION

According to the American Cancer Society, breast cancer is the second leading cause of death in women, with 40,610 breast cancer deaths expected to occur among US women in 2017. (See, e.g., Reference 24). Thus, prevention and early detection can be important in reducing or minimizing breast cancer mortality. Family history, genetic mutations such as BRCA 1 and 2, and hormonal risk factors are some of the established risk factors that increase breast cancer risk. (See, e.g., References 25-27). High mammographic breast density can correlate with breast cancer risk. (See, e.g., References 28-30).

The breast is composed of fat and fibroglandular tissue (“FGT”), which can include epithelial and stromal elements. Mammographic breast density can correlates to the amount of FGT on breast MRI. Depending on the amount of FGT, the breast is classified into four different categories determined by the Breast Imaging Reporting and Data System (“BI-RADS”) lexicon, which can include almost entirely fatty, scattered fibroglandular tissue, heterogeneous fibroglandular tissue, and extreme fibroglandular tissue on breast MRI, (see, e.g., Reference 31), which can correspond to almost entirely fatty, scattered areas of fibroglandular density, heterogeneously dense, and extremely dense categorizations on mammography. Patients with heterogeneously dense or extremely dense breasts can have a fourfold increased risk of developing breast cancer compared to patients with fatty breasts. (See, e.g., References 28-30).

Breast magnetic resonance imaging (“MRI”) parenchymal enhancement (“BPE”) refers to the volume and intensity of normal FGT enhancement after intravenous contrast administration on breast MRI. Similar to FGT categorization, the amount of BPE can be qualitatively assessed by the interpreting radiologist based on the BI-RADS lexicon as minimal, mild, moderate, or marked. (See, e.g., Reference 31). It has been shown that the amount of breast MRI BPE can be a significant risk factor for breast cancer, independent of the amount of FGT. (See, e.g., References 32 and 33). Similar to mammographic density, there is an association between a high degree of BPE and breast cancer. (See, e.g., References 33 and 34).

Currently, both FGT and BPE are qualitatively assessed by the interpreting radiologist. Such assessment can be prone to inter- and intra-observer variability due to the inherent subjectivity of the interpretation. (See, e.g., Reference 34). Quantitative three-dimensional assessments of FGT and BPE using semi-automated computerized methods have been published. (See, e.g., References 35-39). While quantitative methods provide a more accurate measurement of FGT and BPE (see, e.g., References 35-39), they are time-consuming, and may require initial selection of the region of interest by the operator, which introduces potential subjectivity bias.

Axillary lymph node status can be a beneficial prognostic factor in patients with early-stage breast cancer. Morbidities associated with axillary lymph node dissection have led to the development of sentinel lymph node biopsy (“SLNB”) to reduce the rate of negative axillary clearances. (See, e.g., References 1 and 2). Reported sensitivity rates of intraoperative sentinel lymph node (“SLN”) evaluation for breast cancer range from about 58 to 72% (see, e.g., References 3-5), and accuracy rate of 75%. (See, e.g., Reference 6). These rates are consistent with recently published 33% false negative (“FN”) rates for intraoperative SLN. (See, e.g., Reference 7).

Although SLNB is a minimally invasive procedure, it is still associated with morbidities, which include a risk of lymph-edema with about 8.2% at 12 months. (See, e.g., Reference 8). Other complications, such as, e.g., seroma, localized swelling, pain and paresthesia, infectious neuropathy, decreased arm strength, and shoulder stiffness have been reported in up to 19.5% of patients with SLNB. (See, e.g., Reference 9). There is potential for non-invasive imaging procedure for axillary evaluation that can be comparable to SLNB without the associated comorbidities. Prior studies have investigated axillary ultrasound (“AUS”) and positron emission tomography-computer tomography (“PET-CT”) for evaluation of the axillary lymph nodes. These modalities have shown only moderate accuracy and sensitivity for detecting metastatic axillary lymph nodes, with about 67-77% accuracy and about 43.5-72.3% sensitivity for AUS and about 81.1% accuracy and about 56-62.7% sensitivity for PET-CT. (See, e.g., References 10-12). In addition, AUS is operator dependent, and PET-CT involves potentially harmful ionizing radiation exposure.

Mammography is generally the gold standard for breast cancer screening as it is the most cost-effective imaging modality. However, MRI has gained popularity in recent years as the most sensitive imaging procedure, excelling in diagnosis, preoperative planning, and prognostication of breast cancers. (See, e.g., References 51-53).

Given disease heterogeneity, tissue sampling is the gold standard with immunohistochemistry (“IHC”) used as surrogate genetic testing to determine breast cancer subtype. Based on gene expression, cancer cells express various receptors, such as, estrogen receptor (“ER”), progesterone receptor (“PR”) and the human epidermal growth factor receptor (“HER2”). (See, e.g., Reference 50). Four intrinsic breast cancer subtypes have been described, e.g., luminal A (e.g., hormone receptor positive, HER2 negative); luminal B (e.g., hormone-receptor positive, HER2 positive or negative), HER2 enriched type (e.g., hormone-receptor negative, HER2 positive) and triple negative subtype (e.g., hormone-receptor negative, HER2 negative). (See, e.g., References 50, 54 and 55).

Despite advantages with the use of IHC surrogates, the range of agreement between its use in predicting breast cancer subtype and explicit genetic testing is between 41-100%. (See, e.g., Reference 56). Given the wide spectrum of prognosis and indicated treatment strategies based on tumor subtype, a need exists for more accurate diagnosis to aid in an individualized treatment plan. (See, e.g., References 57-59).

Due to rapid advancements in quantitative radiology methods (e.g., radiomics), tumor biology and genetics can be evaluated in a more precise, predictive, and cost-effective way. Quantitative radiomics extracts data from routine medical imaging, and analyses high fidelity complex imaging features, unperceivable to the human eye. (See, e.g., Reference 60). Radiogenomics is the process of linking the radiomics to the hidden genotypic configuration of a tumor or tissue. (See, e.g., Reference 61). Radiogenomics of breast cancer using MRI is based on various intrinsic features including dynamic contrast enhancement (“DCE”) kinetics, which often define tumor heterogeneity, to predict molecular subtype. (See, e.g., References 62-65).

Utilizing the breast MRI modality for axillary evaluation reportedly shows low intra- and inter-observer variability and higher diagnostic accuracy (71-85%) and sensitivity 47.8-89% for nodal status. (See, e.g., References 12-15). Although MRI is the most promising of the imaging modalities, previously published studies can be limited by small sample size and subjective identification of the region of interest manually defined within the lymph node by the reader.

In recent years, there has been a quantitative analysis of specific extracted imaging features, termed “radiomics.” The field of radiomics has developed largely due to the contribution of machine learning procedures utilizing the extraction of pertinent imaging features and correlating them with clinical data. A subset of machine learning utilizing a type of artificial neural network called a convolutional neural network (“CNN”) has begun to proliferate due to advances in computer hardware technology for medical imaging analysis. In contrast to traditional procedures which utilize hand-crafted features based on human-extracted patterns, neural networks facilitate the computer to automatically construct predictive statistical models, tailored to solve a specific problem subset. (See, e.g., Reference 16).

Thus, it may be beneficial to provide an exemplary system method and computer-accessible medium for classifying tissue using at least one convolutional neural network which can overcome at least some of the deficiencies described herein above.

### SUMMARY OF EXEMPLARY EMBODIMENTS

An exemplary system, method and computer-accessible medium for classifying a tissue(s) of a patient(s) can include, for example, receiving an image(s) of an internal portion(s) of a breast of the patient(s), and automatically classifying the tissue(s) of the breast by applying a neural(s) network to the image(s). The tissue(s) can include a lymph node(s). The lymph node(s) can be classified as a cancerous tissue or a non-cancerous tissue. The tissue(s) can be classified as a fibroglandular tissue or a background parenchymal enhancement tissue. The tissue(s) can be classified as a cancer molecular subtype. The image(s) can be is a magnetic resonance image.

In some exemplary embodiments of the present disclosure, the neural network can be a CNN. The CNN can include a plurality of layers. The layers can include (i) a plurality of convolutional layers, (ii) a plurality of rectified linear unit layers, and (iii) a plurality of fully connected layers. At least one of the fully connected layers can include 512 neurons. The layers can include (i) a plurality of convolutional layers, (ii) a plurality of residual layers, and (iii) a plurality of linear layers. The CNN can include a collapsing and expanding CNN. An expanding arm of the collapsing and expanding CNN can include a plurality of convolutional filters and a plurality of strided convolutions, and a collapsing arm of the collapsing and expanding CNN can include a plurality of convolutional transpose filters.

In certain exemplary embodiments of the present disclosure, A score(s) can be determined based on the image(s) using the neural network(s). The tissue can be automatically classified based on the score(s) (e.g., a score above 0.5). Intensity values in the image(s) can be normalized, for example, using a z score map(s).

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIGS. 1A-1C are exemplary images after pre-processing of metastatic lymph nodes according to an exemplary embodiment of the present disclosure;

FIGS. 2A-2C are exemplary images of pre-processing of negative control lymph nodes according to an exemplary embodiment of the present disclosure;

FIG. 3 is an exemplary diagram of an exemplary convolutional neural network according to an exemplary embodiment of the present disclosure;

FIG. 4 is an exemplary diagram of a further exemplary convolutional neural network according to another exemplary embodiment of the present disclosure;

FIG. 5 is an exemplary image of a whole breast segmentation according to an exemplary embodiment of the present disclosure;

FIG. 6A is an exemplary T1 sagittal pre-contrast image according to an exemplary embodiment of the present disclosure;

FIG. 6B is an exemplary T1 sagittal post-contrast image according to an exemplary embodiment of the present disclosure;

FIG. 6C is an exemplary image of FGT and BPE segmentation according to an exemplary embodiment of the present disclosure;

FIG. 7A is a further exemplary T1 sagittal pre-contrast image according to an exemplary embodiment of the present disclosure;

FIG. 7B is a further exemplary T1 sagittal post-contrast image according to an exemplary embodiment of the present disclosure;

FIG. 7C is an enhanced exemplary image of FGT and BPE segmentation according to an exemplary embodiment of the present disclosure;

FIG. 8A is an even further exemplary T1 sagittal pre-contrast image according to an exemplary embodiment of the present disclosure;

FIG. 8B is an even further exemplary image of FGT and BPE segmentation according to an exemplary embodiment of the present disclosure;

FIG. 9 is a set of histograms illustrating a histogram normalization of the magnetic resonance images according to an exemplary embodiment of the present disclosure;

FIG. 10 is a set of images of a single input example module with multiple random affine warps applied for data augmentation according to an exemplary embodiment of the present disclosure;

FIG. 11 is an exemplary diagram of a further exemplary convolutional neural network according to an exemplary embodiment of the present disclosure;

FIG. 12 is an exemplary flow diagram of a method for classifying tissue of a patient according to an exemplary embodiment of the present disclosure; and

FIG. 13 is an illustration of an exemplary block diagram of an exemplary system in accordance with certain exemplary embodiments of the present disclosure.

Throughout the drawings, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments and is not limited by the particular embodiments illustrated in the figures and the appended claims.

### DETAILED DESCRIPTION OF EXEMPLARY EMBODIMENTS

The exemplary system, method, and computer-accessible medium, according to an exemplary embodiment of the present disclosure, can include an exemplary determination breast cancer response using various exemplary imaging modalities. For example, the exemplary system, method, and computer-accessible medium according to an exemplary embodiment of the present disclosure is described herein using mammographic images and/or optical coherence tomography (“OCT”) images. However, the exemplary system, method, and computer-accessible medium according to an exemplary embodiment of the present disclosure can also be used on other suitable imaging modalities, including, but not limited to, magnetic resonance imaging, positron emission tomography, ultrasound, and/or computed tomography.

A CNN can be a deep artificial neural network that automatically constructs predictive statistical models, tailored to solve a specific problem subset. Such CNN can facilitate the technology to self-optimize and discriminate through increasingly complex layers. (See, e.g., Reference 16). The purpose of this study is to develop an objective and accurate approach to MRI axillary evaluation applying a novel CNN procedure.

### Exemplary Axillary Lymph Node Evaluation

An retrospective review identified biopsy-proven 133 metastatic axillary lymph nodes on core biopsy from 133 patients. One hundred forty-two negative control lymph nodes were identified based on benign biopsies and subsequent negative SLN evaluation in 100 patients, and from 42 healthy MRI screening patients with at least 3 years of negative follow-up.

### Exemplary MRI Acquisition And Analysis

MRI was performed on a 1.5-T or 3.0-T commercially available system using an eight-channel breast array coil. A bilateral sagittal T1 weighted fat-suppressed fast spoiled gradient-echo sequence (e.g., 17/2.4; flip angle, 35°; bandwidth, 31-25 Hz) was then performed before and after a rapid bolus injection (e.g., gadobenate dimeglumine/Multihance; Bracco Imaging; 0.1 mmol/kg) delivered through an IV catheter. Image acquisition began after contrast material injection, and was obtained consecutively with each acquisition time of 120 s. Section thickness was about 2-3 mm using a matrix of 256×192 and a field of view of 18-22 cm. Frequency was in the antero-posterior direction.

### Exemplary Image Pre-Processing

For all patients, lymph nodes were segmented by a breast fellowship trained radiologist with 8 years of experience using 3D Slicer (see, e.g., Reference 17), based on the first T1-W post contrast subtraction images. For each segmented lymph node, the slice with the largest cross-sectional area as determined on any orthogonal plane (e.g., axial, sagittal, or coronal) was identified. The center of mass for each two-dimensional (“2D”) cross-sectional region of interest (“ROI”) was used as a landmark to create a uniform 4.0×4.0 cm bounding box around the lymph node of interest. A fixed size bounding box methodology was chosen to preserve relative size of lymph nodes from patient to patient.

All 2D images were rescaled to a 32×32 voxel resolution. The intensity values were normalized by conversion to a z score map. In addition, the ROI mask was dilated by five voxels, and every voxel outside the mask was set to a z score of −5.

Data augmentation included real-time modifications to the source images at the time of training. 50% of all images in a mini-batch were modified randomly by (i) the addition across all pixels of a scalar between [− 0.1, 0.1] in order to simulate the effect of random Gaussian noise from different acquisition parameters and (ii) the random affine transformation of the original image, which can modify each lymph node slightly utilizing a rigid transformation, ensuring that the same lymph node appears as a unique input to the exemplary neural network. For a two-dimensional affine matrix, such as, for example,

$$[ \begin{matrix}{s}_{l} & {t}_{1} & {r}_{1} \\ {t}_{2} & {s}_{2} & {r}_{2} \\ 0 & 0 & 1\end{matrix} ]$$

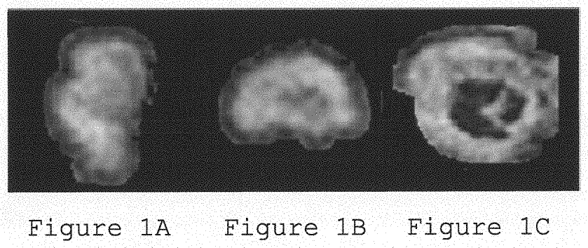

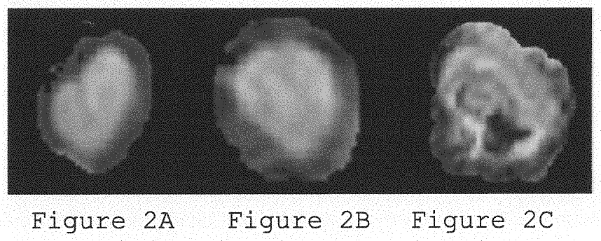

the random transformation was initialized with random uniform distributions of interval s₁, s₂ ∈ [0.8, 1.2], t₁, t₂ ∈ [−0.3, 0.3], and r₁, r₂ ∈ [−16, 16]. These parameters were confirmed on visual inspection. Data augmentation to 50% of the example images was utilized to bias the network towards recognition of real data over augmented data. FIGS. 1A-1C are exemplary images after pre-processing of metastatic lymph nodes according to an exemplary embodiment of the present disclosure. FIGS. 2A-2C are exemplary images of pre-processing of negative control lymph nodes according to an exemplary embodiment of the present disclosure.

### Exemplary Neural Network Architecture

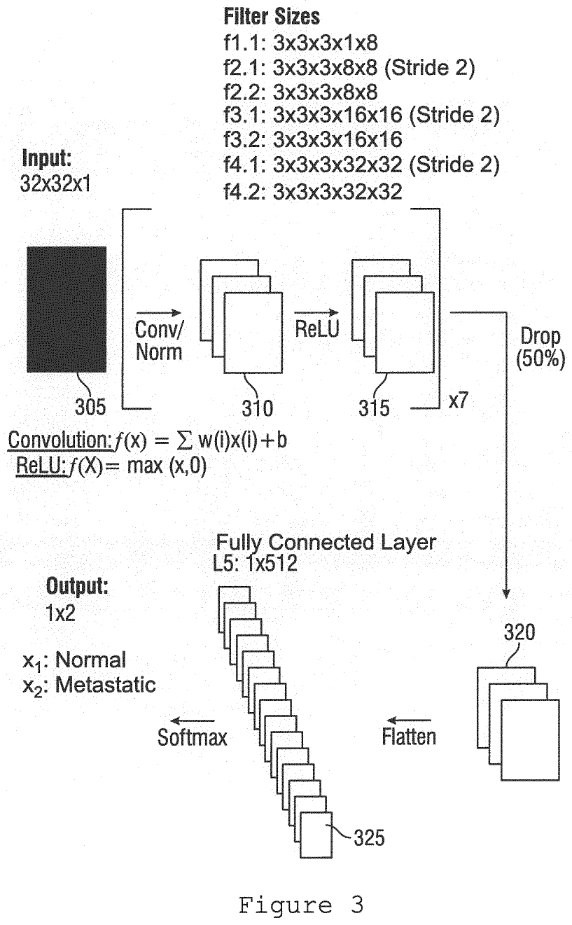

FIG. 3 shows an exemplary diagram of an exemplary convolutional neural network according to an exemplary embodiment of the present disclosure. The exemplary CNN can be implemented using a series of 3×3 convolutional kernels to prevent overfitting, (see, e.g., Reference 18), and can be implemented with or without pooling layers. If no pooling layers are utilized, downsampling can be implemented using a 3×3 convolutional kernel with stride length of 2 to decrease the feature maps by 75% in size. All non-linear functions can utilize a rectified linear unit (“ReLU”) which can facilitate training of deep neural networks by limiting vanishing gradients on backpropagation. (See, e.g., Reference 19). Additionally, batch normalization can be performed between the convolutional and ReLU layers to stabilizing training by limiting vanishing gradients, and to prevent covariate shift. (See, e.g., Reference 20). After downsampling, the number of feature channels can be doubled, reflecting increasing representational complexity and to prevent a representation bottleneck. Dropout at 50% was applied to the second to last fully connected layer to limit overfitting, and to add stochasticity to the exemplary training process. (See, e.g., Reference 21).

As shown in the diagram of FIG. 3, an exemplary image 305 can be input into a plurality of combined convolutional/normal layers 310 (e.g., three layers). A plurality of ReLu layers 315 can be implemented (e.g., three ReLu layers). Dropout can be applied to the fully connected layer 320 (e.g., which can include three fully connected layers. A final fully connected layer 325, with 512 neurons, can be incorporated, which can be used to output a Softmax score.

The exemplary training was implemented using the Adam optimizer, a procedure for first-order gradient-based optimization of stochastic objective functions, based on adaptive estimates of low order moments. (See, e.g., Reference 22). Parameters were initialized to equalize input and output variance utilizing a suitable heuristic. (See, e.g., Reference 23). L2 regularization was utilized to prevent overfitting of data by limiting the squared magnitude of the kernel weights. To account for training dynamics, the learning rate was annealed, and the mini-batch size was increased whenever the training loss plateaued. A normalized gradient procedure was utilized to facilitate locally adaptive learning rates that can adjust according to changes in the input signal. (See, e.g., Reference 22).

Due to the small sample size, five-fold cross-validation was utilized to evaluate network performance, which was split into 80% training data and 20% testing data. This included splitting the available data into five random groupings. One of the groups was utilized as the initial testing set to fine tune the parameters of the network trained on the other five groups. After parameter tuning was performed, the group utilized as the validation set was changed, and the network was retrained on the remaining four groups using the same parameters. The process was repeated until every one of the five groups of data was utilized as a validation set once.

### Exemplary Results

A total of 142 metastatic lymph nodes and 133 normal lymph nodes were examined. For each lymph node, a final softmax score threshold of 0.5 was used for classification. Based on this, mean five-fold cross-validation accuracy was calculated at 84.3%. Manual inspection of false positive and false negative predictions of the network revealed no discernibly consistent features that consistently lead to false negative or false positive classifications from the network. The exemplary CNN was trained for a total of 22,000 iterations (e.g., approximately 1500 epochs with batch sizes ranging from 12 to 24) before convergence. A single forward pass during test time for classification of new cases was achieved in 0.0043 s.

Prior studies evaluating the axilla with MRI have reported an averaged accuracy rate of 75% (e.g., ranging 71-85%) in predicting axillary metastasis. (See, e.g., References 13-15). In a retrospective study, performance of AUS, MRI, and PET-CT in detection of axillary lymph node metastasis (“ALNM”) was analyzed. AUS, MRI, and PET-CT had accuracies of about 77.1, about 77.9, and about 81.1% respectively. The combination of MRI and PET-CT was most accurate with an accuracy of 83.1%. However, routine use of both MRI and PET-CT for axillary evaluation may not be cost effective.

In a retrospective analysis (see, e.g., Reference 14), performance of breast MRI was assessed on both a patient-by-patient and a node-by-node analysis, which included 505 patients. Their patient pool included patients with stages T1-T4. The accuracy of MRI in detection of ALNM was about 69.7-71.3%. A prospective analysis of 50 patients with stages T1-T3 breast cancer, in a patient-by-patient fashion was performed. (See, e.g., Reference 15). The accuracy of MRI in detection of ALNM was about 74%. The performance of MRI in evaluation of ALNM, in 61 patients was evaluated. (See, e.g., Reference 13). The reported accuracy was about 85%. The study was limited by a small sample size (61 patients) and subjective evaluation of the lymph nodes. Furthermore, there was poor inter-observer agreement, when interpreting qualitatively the T1-weighted images, (k=0.57 for first reading and k=0.78 for second readings).

In contrast to the studies discussed above, the exemplary system, method, and computer-accessible medium, according to an exemplary embodiment of the present disclosure, can utilize an exemplary CNN to achieve an accuracy rate of about 84%, which can be comparable to the highest accuracy of previous results. (See, e.g., References 13-15). Thus, the exemplary system, method, and computer-accessible medium can be trained to predict likelihood of axillary lymph node metastasis.

### Exemplary Quantification of Breast MRI Fibroglandular Tissue and Background Parenchymal Enhancement

### Exemplary MRI Acquisition

137 patients were selected for analysis. In patients with a breast tumor, only the contralateral normal breast was included for evaluation. MRI was performed on a 1.5 or 3.0-T commercially available system using an eight-channel breast array coil. The imaging sequence included a triplane localizing sequence followed by a sagittal fat-suppressed T2-weighted sequence (e.g., TR/TE, 4000-7000/85; section thickness, 3 mm; matrix, 256×192; FOV, 18-22 cm; no gap). A bilateral sagittal T1-weighted fat-suppressed fast spoiled gradient-echo sequence (17/2.4, flip angle, 35°, bandwidth, 31-25 Hz) was then performed before, and three times after a rapid bolus injection (e.g., gadobenate dimeglumine/Multihance; Bracco Imaging; 0.1 mmol/kg) delivered through an IV catheter. Exemplary image acquisition began after contrast material injection, and was obtained consecutively up to four times with each acquisition time of 120 s. Section thickness was 2-3 mm using a matrix of 256×192 and a field of view of 18-22 cm. Frequency was in the antero-posterior direction. After the examination, post-processing was performed, including subtraction of the unenhanced images from the first contrast-enhanced images on a pixel-by-pixel basis, and reformation of sagittal images to axial images.

### Exemplary Ground Truth Segmentation and Quantification

Ground truth segmentation and quantification was performed. (See, e.g., References 35-37). For each breast, the outer margins of the entire breast, as well as margins for fibroglandular tissue, were manually segmented using custom semi-automated software. The software was based on an active contour procedure that was iteratively refined after manually initiated segmentations. All segmentation masks were visually inspected by a board-certified subspecialized breast radiologist with 8 years of experience. FGT calculation was based on FGT volume/whole breast volume. BPE calculation was based on BPE volume/FGT volume. (See, e.g., References 35-37).

### Exemplary Image Preprocessing

Each breast MRI was split into two separate volumes, one containing each of the two breasts. These volumes were then resized to an input matrix of 64×128×128 using bicubic interpolation, yielding an approximately isotropic volume. Each volume was then independently normalized using z score values, such that the mean and standard deviation voxel value for each volume were 0 and 1, respectively. For whole breast segmentation, all available sequences were utilized for training. For subsequent FGT segmentation, only T1 pre-contrast volumes were utilized.

### Exemplary Convolutional Neural Network

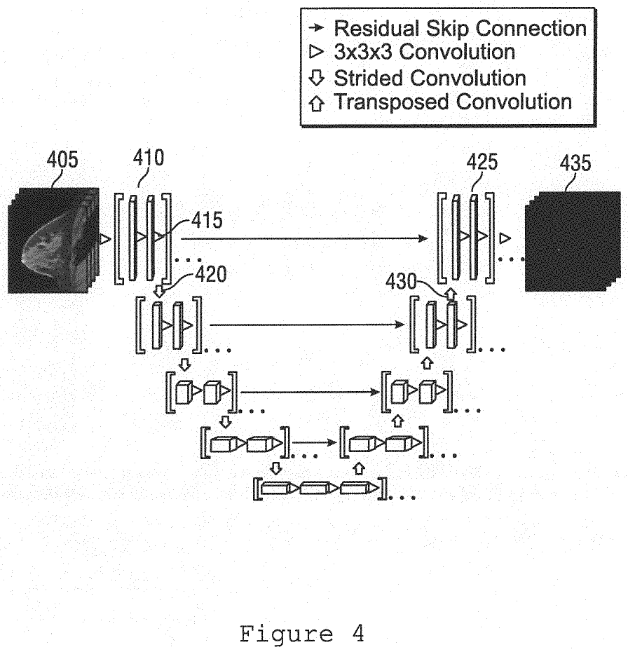

FIG. 4 shows an exemplary diagram of a further exemplary convolutional neural network according to another exemplary embodiment of the present disclosure. For example, an image 405 can be input into two serial fully convolutional three-dimensional (“3D”) CNNs were utilized for voxel-wise prediction of whole breast and FGT margins. The predicted whole breast margins can be used to mask the original MRI volume such that FGT can only be predicted in areas identified as breast parenchyma.

In the collapsing arm of the network 410, a series of 3D convolutional filters 415 of size 3×3×3 can be applied for CNN hierarchical feature extraction, which can have feature map sizes of, for example, 128-64-32-16-8-8-16-32-64-128 and a depth of, for example, 8-16-32-64-96-96-64-32-16-8. To reduce feature map dimensionality, a 3×3×3 convolutional filter 420 with stride 2 in all directions can be applied; a total of four such operations can be used. In the expanding arm of the network 425, a series of convolutional transpose filters 430 of size 3×3×3 can be used to up-sample each intermediate layer. To synthesize features at multiple resolutions, connections can be introduced between the collapsing arm 410 and the expanding arm 425 of the network. These can be implemented through residual connections (e.g., addition operations) (see, e.g., Reference 43), instead of concatenations (see, e.g., Reference 44), given the overall increased stability and speed of procedure convergence of residual architectures.

Pooling layers may optionally be utilized to, for example, to preserve flow of gradients during back-propagation, although such pooling layers are not needed for such utilization. (See, e.g., Reference 44). Thus, the exemplary CNN can facilitate efficient and flexible prediction during deployment such that outputs in image 435, at every voxel location, can be obtained in just a single forward pass regardless of the number of input slices in the volume.

The exemplary network was trained from random weights initialized using a suitable heuristic. (See, e.g., Reference 45). The final loss function included a term for L2 regularization to prevent over-fitting of data by limiting the squared magnitude of the convolutional weights. Gradients for back-propagation were estimated using the Adam optimizer, a procedure for first-order gradient-based optimization of stochastic objective functions based on adaptive estimates of lower order moments. (See, e.g., Reference 46). The default Adam optimizer parameters were used. This included beta-1=0.9, beta-2=0.999, epsilon=1e-8. An initial learning rate of 0.001 was used and annealed (along with an increase in mini-batch size) whenever a plateau in training loss was observed.

### Exemplary Statistical Analysis

Procedure accuracy in mask generation used for FGT and BPE quantification was determined using two different metrics. As an initial matter, predicted whole breast, FGT, and BPE volumes were compared to gold-standard manual segmentations using a Dice score coefficient of, for example:

$$Dice = \frac{2 \vert X ⋂ Y \vert}{\vert X \vert + \vert Y \vert}$$

The Dice score estimates the amount of spatial overlap (e.g., union) between two binary masks, with a score of 0 indicating no overlap and a score of 1 indicating perfect overlap. Second, predicted whole breast, FGT, and BPE volumes (cm3) were compared to gold-standard annotated volumes using a Pearson correlation coefficient (r).

### Exemplary Results

A total of 1114 breast volumes of 169 single breasts from 137 patients were included for evaluation. When available, T1 pre-contrast, T1 post-contrast (e.g., up to three phases), and T1 subtraction (up to three phases) acquisitions were used for each breast, yielding a total of 1114 single breast volumes. A five-fold cross-validation procedure was used for analysis. 80% of the data was randomly assigned into the training cohort while the remaining 20% was used for validation. This process was then repeated five times until each study in the entire dataset was used for validation at least one. During randomization, all breast volumes arising from the same patient were kept in the same validation fold. Final results below are shown for the cumulative validation set statistics across the entire dataset, with ranges indicating minimum and maximum values observed in any single validation fold.

### Exemplary Whole Breast, FGT, and BPE Segmentation and Quantification

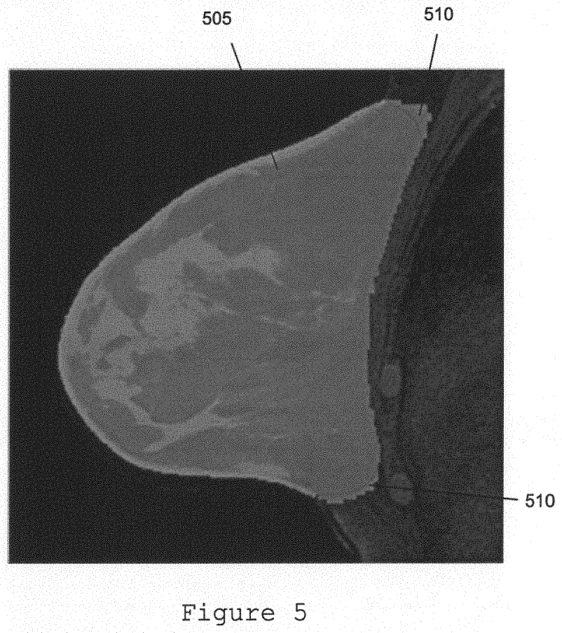

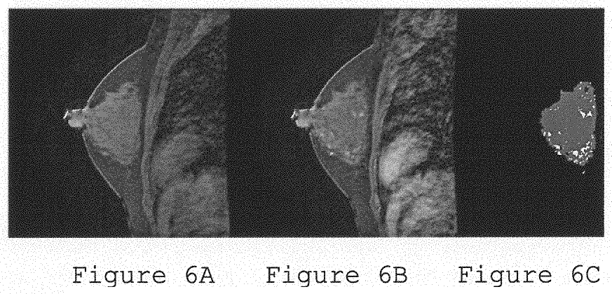

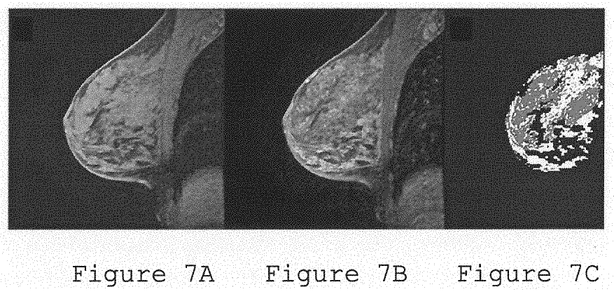

The exemplary CNN-generated masks of whole breast volume show high accuracy, with cross-validation Dice score coefficient of 0 about 0.947 and Pearson correlation of about 0.998 in comparison to the manual annotations shown in the image shown in FIG. 5. Visually, the 3D CNN network generated smooth mask boundaries 505 in each dimension, as opposed to the “stair-step” artifact 510 that can typically be encountered when estimating margins on a 2D slice-by-slice basis. Additionally, the exemplary CNN generated masks of FGT and quantified BPE with high accuracy in matching the ground truth quantification results (e.g., Dice score coefficient of about 0.813 and Pearson correlation of about 0.975 for FGT and Dice score coefficient of 0.829 and Pearson correlation of about 0.955 for BPE). Examples of FGT segmentation and BPE images are illustrated in exemplary images of FIGS. 6A-6C and 7A-7C.

### Exemplary Network Statistics

Each network for a corresponding validation fold was trained for approximately 80,000 iterations before convergence. The exemplary system, method, and computer-accessible medium, according to an exemplary embodiment of the present disclosure, can used a trained network to determine whole breast and FGT margins, as well as estimates of BPE on a new test case within an average of 0.42 s.

The exemplary system, method, and computer-accessible medium, according to an exemplary embodiment of the present disclosure, can utilize a U-Net architecture for fully automated segmentation and quantification of breast FGT and BPE, which can be beneficial imaging biomarkers of breast cancer risk. The exemplary results show high degree of accuracy in quantifying FGT and BPE and indicate feasibility of utilizing CNN procedure to accurately and objectively predict these important measures.

There are a number of published FGT and BPE qualitative and quantitative assessment studies that have been performed. (See, e.g., References 35-39). Qualitative FGT and BPE assessment can be prone to inter- and intra-observer variability due to the inherent subjectivity of the interpretation. (See, e.g., Reference 34). In addition, categorizing the amount of FGT and BPE into only four qualitative groups limits statistical analysis assessing for small but potentially significant differences. Quantitative 3D assessment studies have also been published, showing a more accurate assessment of FGT and BPE volume. One study utilizes custom semi-automated software, which can be based on an active contour procedure that can be iteratively refined after manually initiated segmentations. (See, e.g., References 35-37). Others have used techniques such as fuzzy c-means (“FCM”) data clustering procedure (see, e.g., Reference 38), and principal component analysis (“PCA”). (See, e.g., Reference 39). While there can be significant advantages in 3D assessment of FGT and BPE, including robust segmentation with easy initialization and efficient modification, such segmentation software can be time-consuming. Furthermore, they often rely on segmentation masks being visually inspected by a subspecialized breast radiologist for accuracy, which can introduce inter- and intra-observer variability.

More fully automated whole breast and FGT segmentation procedures have been discussed. (See, e.g., Reference 47). A multistep process, including the identification of landmarks, such as a sternum, which used the expectation-maximization procedure, was used to estimate the image intensity distributions of breast tissue and automatically discriminate between fatty and fibroglandular tissue. A dataset of 50 cases with manual segmentations was used for evaluation yielding reasonable results. However, the multistep process was time-consuming, taking approximately 8 min. In contrast, the exemplary system, method, and computer-accessible medium can be significantly faster even accounting for the differences in the hardware capacity with result output in a fraction of a second. In addition, the performance of the previous study was based on overlap of the manual segmentation. It was not clear if the manual segmentation has clinical validation with a known standardized value such as qualitative BI-RADS assessment. The exemplary ground truth segmentation was based on validation with BI-RADS assessments. (See, e.g., References 35-37).

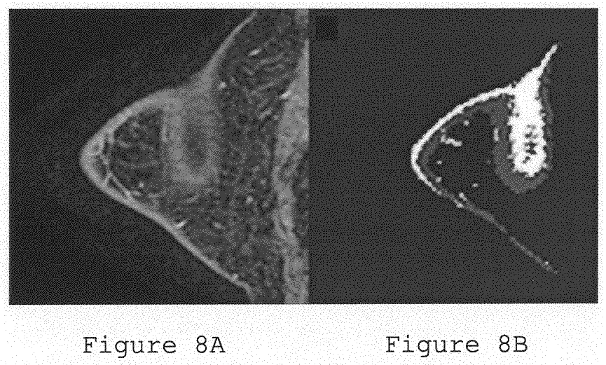

In contrast to the previous procedures, the exemplary system, method, and computer-accessible medium according to the exemplary embodiments of the present disclosure can utilize an exemplary 3D U-Net, which can be a convolutional network architecture for fast and precise segmentation of images. Network and training strategies that are based on the strong use of data augmentation can use the available annotated samples more efficiently. (See, e.g., References 41 and 42). The exemplary CNN can include a contracting path to capture context and a symmetric expanding path that facilitates precise localization facilitating for segmentation with less number of training cases. The exemplary system, method, and computer-accessible medium according to the exemplary embodiments of the present disclosure provide a high degree of accuracy in quantifying FGT and BPE utilizing a 3D U-Net architecture to predict these important measures. The exemplary system, method, and computer-accessible medium, according to an exemplary embodiment of the present disclosure, can be based on magnetic resonance (“MR”) images. However, minor errors in segmentation were most commonly seen on MR acquisitions with relatively poor fat saturation along the subcutaneous skin margins. These segmentation discrepancies were most evident when incomplete fat saturation was combined with volume averaging in the out-of-plane direction resulting in apparent high signal intensity centrally within the breast tissue. (see e.g., exemplary images shown in FIGS. 8A and 8B). These errors can, in part, be related to the down-sampling utilized to accommodate GPU memory limitations for otherwise high-resolution 3D volumes, which can result in increased slice gap, and thus the inability of the procedure to smoothly trace the central signal abnormality to the periphery of the skin.

In order to address overfitting, the final loss function in the exemplary CNN included a term for L2 regularization to prevent over-fitting of data by limiting the squared magnitude of the convolutional weights. The exemplary procedure was performed using fivefold cross-validation. This facilitates an unbiased predictor, but running the exemplary CNN on a separate and independent testing dataset can produce a more objective evaluation. For the exemplary data, before normalization, no bias field correction was applied. Bias field correction (e.g., N4 bias field correction) can be the correction of the image contrast variations due to magnetic field inhomogeneity. (See, e.g., Reference 48). In addition, there can be several parameters that need to be carefully tuned in the exemplary network such as L2 regularizer, optimizer, and learning rate. Currently, all the parameters were determined empirically.

### Exemplary Predicting Breast Cancer Molecular Subtype

216 patients with known breast cancer diagnosis who underwent preoperative MRI prior to any treatment and who had available IHC staining pathology data were identified. Subtypes were classified by IHC staining surrogates as (i) luminal A (e.g., ER and/or PR+, HER2-), (ii) luminal B (e.g., ER and/or PR+, HER2+), (iii) HER2 (e.g., ER and PR−, HER2+), or (iv) basal (e.g., ER−, PR−, HER2−) (30-32). Tumors were considered HER-2 positive only if scored 3+ by IHC or if HER-2 amplification yielded a ratio >=2.0 on the basis of fluorescence in situ hybridization (FISH). (See, e.g., References 54 and 76-78).

### Exemplary MRI Acquisition

MRI was performed on a 1.5-T or 3.0-T commercially available system using an eight-channel breast array coil. The exemplary imaging sequence included a triplane localizing sequence followed by a sagittal fat-suppressed T2-weighted sequence (e.g., TR/TE, 4000-7000/85; section thickness, 3 mm; matrix, 256×192; FOV, 18-22 cm; no gap). A bilateral sagittal T1-weighted fat-suppressed fast spoiled gradient-echo sequence (e.g., 17/2.4; flip angle, 35°; bandwidth, 31-25 Hz) was then performed post rapid bolus injection (e.g., gadobenate dimeglumine/Multihance; Bracco Imaging; 0.1 mmol/kg), which was delivered through an IV catheter. Image acquisition began after contrast material injection, and was obtained consecutively with each acquisition time of 120 seconds. Section thickness was 2-3 mm using a matrix of 256×192 and a field of view of 18-22 cm. Frequency was in the antero-posterior direction. After the examination, post-processing was performed including subtraction of the unenhanced images from the first contrast-enhanced images on a pixel-by-pixel basis, and reformation of sagittal images to axial images.

### Exemplary Data Annotation

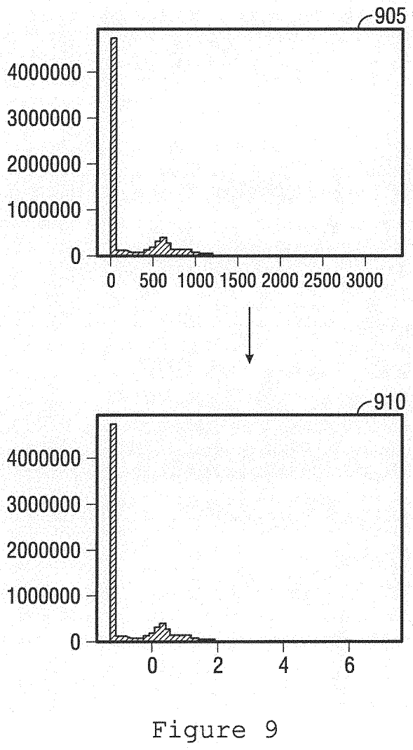

After the breast MRIs were obtained, a fellowship trained breast imaging radiologist subsequently reviewed the MRI images. Anonymized post-contrast MRI DICOM images were downloaded to a password protected external hard-drive and loaded into 3D Slicer 4.0 for medical image informatics and analysis. Binary three dimensional segmentations were applied to the input images. The molecular subtype of each patient's breast cancer as obtained from the EMR was recorded as the ground truth class label. FIG. 9 illustrates a set of exemplary histograms illustrating histogram normalization (e.g., from histogram 905 to histogram 910) of the magnetic resonance images that was performed to center the non-air pixels around 0 with unit standard deviation.

### Exemplary Image Processing

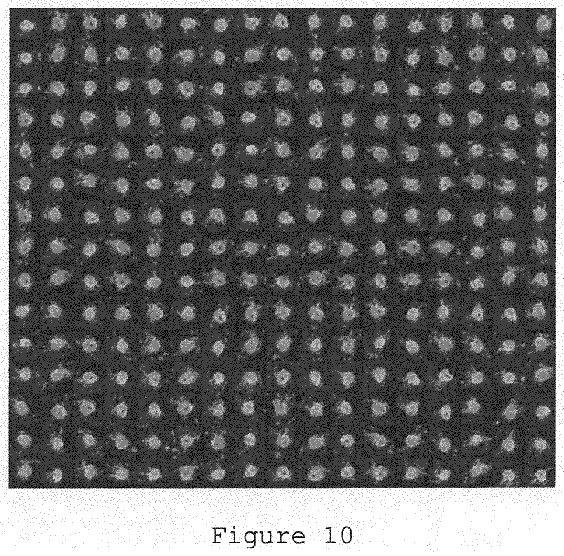

Data augmentation included real-time modifications to the source images at the time of training. These modifications included random affine transformation of the original image, which can alter each mass slightly utilizing a rigid transformation, making the same mass appear as a unique input to the network. Given a three-dimensional affine matrix, random affine warping was performed by utilizing random rotation by ±30°, 90°, and 90° across the Z, Y and X axes respectively. Additionally, a random shear value of 0.1 was applied to each axis. These parameters were confirmed on visual inspection as applying enough of a warp to simulate a different lesion without making the lesion appear unrealistic. FIG. 10 shows a set of exemplary images of a single input example module with multiple random affine warps applied for data augmentation according to an exemplary embodiment of the present disclosure. A data augmentation of 50% of the example images was performed to prevent inducing bias of the network towards recognition of augmented data over real data. Additional augmentation included the addition of (i) a random Gaussian noise matrix, (ii) random contrast jittering and (iii) random brightness. The exemplary CNN was able to learn to marginalize random noise introduced by minor warps in the input volume as well as slight differences in acquisition parameters. Network inputs included 32×32 pixel bounding boxes containing three phases of the size normalized lesions.

### Exemplary CNN Architecture

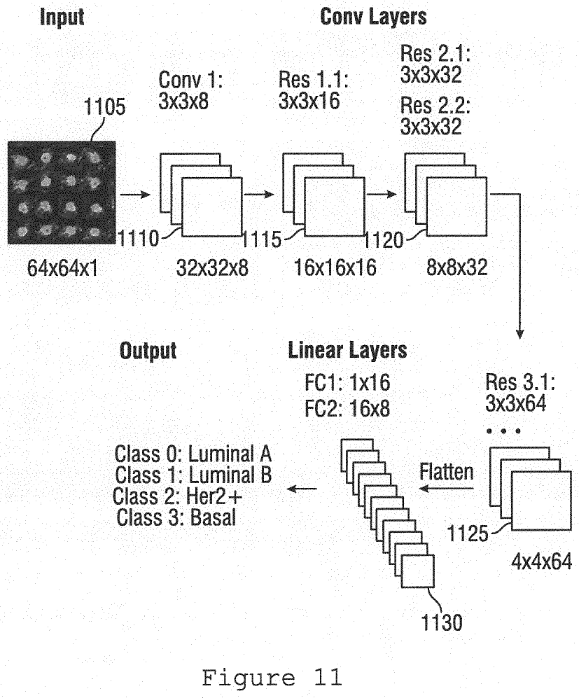

The exemplary CNN was implemented using a series of 3×3 convolutional kernels to maximize computational efficiency while preserving nonlinearity. (See, e.g., Reference 79). FIG. 11 shows an exemplary diagram of the exemplary convolutional neural network according to an exemplary embodiment of the present disclosure. For example, an image 1105 can be input into a plurality of convolutional layers 1110 (e.g., which can include 3 layers). After convolutional layers 1110, a series of residual layers 1115, 1120, and 1125 can be utilized. Residual neural networks 1115, 1120, and 1125 can stabilize gradients during back propagation, leading to improved optimization and facilitating greater network depth. (See, e.g., Reference 32). Downsampling of feature map size was implemented using a concatenated average and max pooling operation to decrease size by 75%. All nonlinear functions can utilize the ReLU which can facilitate training of deep neural networks by stabilizing gradients on backpropagation. (See, e.g., Reference 81). Linear layers 11130 were used to provide an output (e.g., a tissue classification). Additionally, batch normalization was used between the convolutional and ReLU layers to enhance network training by stabilizing the loss landscape. (See, e.g., Reference 82). After downsampling, the number of feature channels can be doubled, preventing a representation bottleneck. Dropout with a keep probability of 50% was applied to the first fully connected layer to limit over-fitting and add stochasticity to the training process. (See, e.g., Reference 83).

In addition to the exemplary CNN described herein, Table 1 below shows various additional network architectures that were evaluated. This included: (i) A ResNet 52 network architecture initialized both randomly and with pre-trained weights from Imagenet, (ii) custom built networks, initialized from random weights, and with varying numbers of convolutional layers based on the Inception v4 architecture, and (iii) 100 layer network based on a randomly initialized Dense Net architecture. Performance for the networks was best when initializing weights randomly across the board. Additionally, three dimensional networks were tested by alternating between using inception style layers, residual style layers and hybrid wide residual layers. Using more than 14 hidden layers in 2D networks, or greater than 8 3D inception style layers, can produce overfitting. Additionally, 3D networks can suffer from overfitting even with as low as 4 hidden layers.

TABLE 1
The Network architecture: Dimensions of all of the intermediate layers
of the convolutional neural network. The first column contains the input
layer names. The second column displays the size of the input feature
map. The middle column describes the type of filter applied followed
by a column describing the filter size if applicable. The final column
displays the name of the output layer, which serves as the input for
the next layer. Residual layers contain two feature maps per layer

| | Input Layer | | | |
|---|---|---|---|---|
| Input Layer | Dimensions | Filter Type | Filter Size | Output Layer |
| Input | 64 × 64 × 3 | Convolutional | 3 × 3 × 8 | Hidden Layer 1 |
| Hidden Layer 1 | 32 × 32 × 8 | Residual | 3 × 3 × 16 | Hidden Layer 2/3 |
| Hidden Layer 2/3 | 16 × 16 × 6 | Residual | 3 × 3 × 32 | Hidden Layer 4/5 |
| Hidden Layer 4/5 | 8 × 8 × 32 | Residual | 3 × 3 × 32 | Hidden Layer 5/6 |
| Hidden Layer 5/6 | 8 × 8 × 32 | Residual | 3 × 3 × 64 | Hidden Layer 6/7 |
| Hidden Layer 6/7 | 4 × 4 × 64 | Residual | 3 × 3 × 64 | Hidden Layer 8/9 |
| Hidden Layer 8/9 | 4 × 4 × 64 | Residual | 3 × 3 × 64 | Hidden Layer 10/11 |
| Hidden Layer 10/11 | 4 × 4 × 64 | Linear | ×16 | Hidden Layer 12 |
| Hidden Layer 12 | 1 × 16 | Linear | 16 × 8 | Hidden Layer 13 |
| Hidden Layer 13 | 1 × 8 | Softmax | 8 × 4 | Classification |

Training was performed using the parameterized Adam optimizer, combined with the Nesterov accelerated gradients. (See, e.g., References 84-86). Parameters were initialized to equalize input and output variance utilizing an exemplary heuristic. (See, e.g., Reference 87). L2 regularization was implemented to prevent over-fitting of data by limiting the squared magnitude of the kernel weights. Hyperparameter settings included a learning rate set to 1e-3, keep probability for dropout of 50%, moving average weight decay of 0.999, and L2 regularization weighting of 1e-4.

### Exemplary Results

Subtypes were classified by IHC staining surrogates as (i) luminal A (e.g., ER and/or PR+, HER2−), (ii) luminal B (e.g., ER and/or PR+, HER2+), (iii) HER2 (e.g., ER and PR−, HER2+) or (iv) basal (e.g., ER−, PR−, HER2−) (30-32). Using this exemplary classification, 74 Luminal A, 106 Luminal B, 13 HER2 enriched and 23 ER negative breast tumors were evaluated. Testing set accuracy was measured at 70%. The class normalized macro area under receiver operating curve (“ROC”) was measured at about 0.853. Non-normalized micro-aggregated AUC was measured at about 0.871, representing improved discriminatory power for the highly represented Luminal A and Luminal B subtypes. Aggregate sensitivity and specificity was measured at about 0.603 and about 0.958, respectively. The exemplary CNN procedure achieved an overall accuracy of about 70% in predicting breast cancer subtype.

Based on disease heterogeneity with variable prognosis and indicated treatment regimens, determining breast cancer subtype can be a beneficial initial step after diagnosis. Defining various molecular subtypes using genetic analysis can be an economically and technically challenging process. Alternative ways using IHC as a surrogate can be widely used; however, the range of agreement between predicting these subtypes using IHC and standard genetic testing can be between 41-100%. (See, e.g., Reference 88). While these exemplary procedures have been validated for clinical use, further methods/procedures for determining breast cancer subtype can be utilized.

Preoperative breast MRI has become increasingly prevalent as its role in diagnosis and treatment planning of breast cancer expands. (See, e.g., Reference 51). With the increasing ubiquity of breast MRI, several prior studies have applied radiogenomics to predict subtype using semi-automated procedures. Triple negative cancers have been demarcated from other molecular subtypes on DCE-MRI using a computer-aided diagnosis (“CAD”) system. (See, e.g., Reference 68). They retrospectively studied 76 breast lesions using quantitative feature extraction with a feed forward feature selection and linear discriminate analysis. Triple negative tumors were found to be more heterogeneous in both texture and enhancement, with a higher degree of tumor tissue compactness. The area under the ROC curve for subtype determination was 0.73 (95% CI: 0.59, 0.87) in triple negative versus non-triple negative subtype, 0.74 (95% CI: 0.60, 0.88) in triple negative versus ER and HER2 positive subtype, 0.77 (95 CI: 0.63, 0.91) in triple negative versus ER positive subtype, and 0.74 (95% CI: 0.58, 0.89) for triple negative versus HER2 positive subtype. While this model improves on discriminating aggressive triple-negative breast cancer subtype, it relies on human MRI feature extraction.

Tumor enhancement dynamics association with luminal type B molecular subtype has been explored. (See, e.g., Reference 69). 48 patients with breast cancer were collected from the Cancer Genome Atlas and Cancer Imaging Archive. 23 imaging features were extracted using computer vision procedures after initial lesion delineation by a trained breast radiologist. Luminal B subtypes were found to have higher lesion enhancement to background parenchymal enhancement ratio (P=0.0015).

Similarly, computational MR imaging features of luminal type A and B molecular subtypes were retrospectively evaluated using semi-automatically extracted imaging features. (See, e.g., Reference 70). Initial annotations were made by fellowship trained breast imagers and subsequently 56 features were extracted using computer vision procedures. Tumor to fibroglandular tissue and the peak enhancement were shown to be main factors in discriminating subtype, with multivariate models able to predict luminal A (P=0.0007) and luminal B (P=0.0063), but not HER2 positive (P=0.2465) or basal subtype (P=0.1014).

In a retrospective review of 60 breast cancers, 90 features were derived from DCE-MRI and selected an optimal set of 24 features for subtype classification using trained multi-class logistic regression classifier computer software. (See, e.g., Reference 65). The prediction model demonstrated high accuracy in overall classification (e.g., AUC=0.869) and in discriminating between luminal A, luminal B, HER2 and triple negative subtypes (AUC=0.867, 0.786, 0.888, and 0.923 respectively). Although significant strides have been made in the improvement of breast cancer subtype prediction based on MRI features, these semi-automated procedures rely on specific human extracted feature analysis.

MRI contrast enhancement patterns have shown promise in determining breast cancer subtype. A retrospective study including 186 patients evaluated the distribution pattern of kinetic parameters of DCE-MRI across breast cancer molecular subtypes. No significant different in delayed phase kinetics was identified. However, a significantly decreased percentage of washout pattern was observed in ER/PR positive/HER2 negative and triple negative cancers. (See, e.g., Reference 73). Various studies have retrospectively reviewed 112 patients with newly diagnosed invasive ductal carcinoma who underwent DCE-MRI. (See, e.g., Reference 74). Kinetic analyses showed significantly increased contrast uptake in HER2-positive molecular subtype, with >100% uptake at early phase in HER2-positive versus luminal AB (93.8+/−0.92 vs. 77.3+/−7.2; P<0.01) and HER2-positive versus triple negative (93.8+/−0.92 vs. 81.3+/−8.2; P<0.05). While significant patters in kinetic analyses of breast tumors have demonstrated predictive strength, these methods continue to rely of limited human extracted MRI features.

Although the studies discussed above have shown promising results in breast MRI data analysis, these methods can be dependent on feature engineering using semi-automated feature extraction. Feature engineering operates by implementing domain knowledge to build feature extractors, which simplify the complex data and create more comprehendible patterns to be applied to procedures. In contrast to these methods, the exemplary system, method, and computer-accessible medium, according to an exemplary embodiment of the present disclosure, can be trained to facilitate automatic extraction of features from the input feed that can be beneficial to the defined problem domain. This can improve the exemplary networks ability to study the input features in an end-to-end manner, using complex, stacked layers to predict a desired output. Thus, the exemplary CNN feature extraction may not be needed with each new MRI, which can facilitate consistent results. Therefore, the exemplary system, method, and computer-accessible medium, according to an exemplary embodiment of the present disclosure, can utilize a CNN to accurately predict (e.g., >70%) breast cancer molecular subtypes.

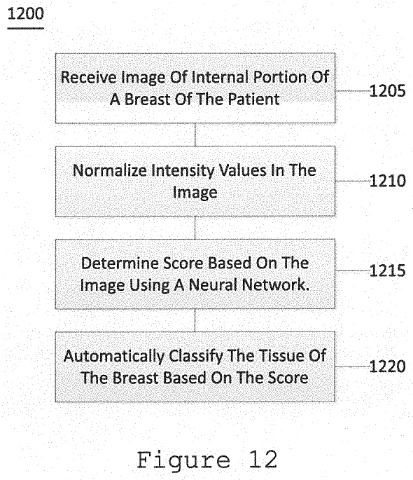

FIG. 12 shows an exemplary flow diagram of a method 1200 for classifying tissue of a patient according to an exemplary embodiment of the present disclosure. For example, at procedure 1205, an image of an internal portion of a breast can be received. At procedure 1210, intensity values in the image can be normalized. At procedure 1215, a score can be determined based on the image using a neural network. At procedure 1220, the tissue of the breast can be automatically classified based on the score.

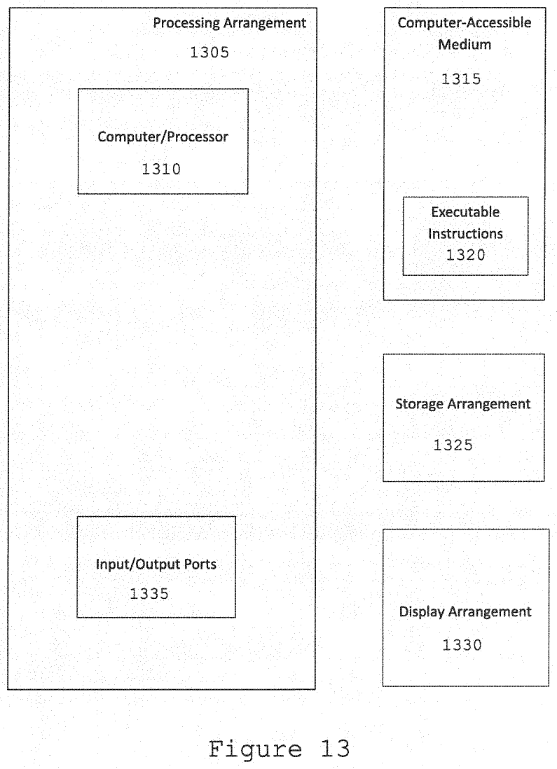

FIG. 13 shows a block diagram of an exemplary embodiment of a system according to the present disclosure. For example, exemplary procedures in accordance with the present disclosure described herein can be performed by a processing arrangement and/or a computing arrangement (e.g., computer hardware arrangement) 1305. Such processing/computing arrangement 1305 can be, for example entirely or a part of, or include, but not limited to, a computer/processor 1310 that can include, for example one or more microprocessors, and use instructions stored on a computer-accessible medium (e.g., RAM, ROM, hard drive, or other storage device).

As shown in FIG. 13, for example a computer-accessible medium 1315 (e.g., as described herein above, a storage device such as a hard disk, floppy disk, memory stick, CD-ROM, RAM, ROM, etc., or a collection thereof) can be provided (e.g., in communication with the processing arrangement 1305). The computer-accessible medium 1315 can contain executable instructions 1320 thereon. In addition or alternatively, a storage arrangement 1325 can be provided separately from the computer-accessible medium 1315, which can provide the instructions to the processing arrangement 1305 so as to configure the processing arrangement to execute certain exemplary procedures, processes, and methods, as described herein above, for example.

Further, the exemplary processing arrangement 1305 can be provided with or include an input/output ports 1335, which can include, for example a wired network, a wireless network, the internet, an intranet, a data collection probe, a sensor, etc. As shown in FIG. 13, the exemplary processing arrangement 1305 can be in communication with an exemplary display arrangement 1330, which, according to certain exemplary embodiments of the present disclosure, can be a touch-screen configured for inputting information to the processing arrangement in addition to outputting information from the processing arrangement, for example. Further, the exemplary display arrangement 1330 and/or a storage arrangement 1325 can be used to display and/or store data in a user-accessible format and/or user-readable format.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

### EXEMPLARY REFERENCES

The following references are hereby incorporated by reference in their entireties:
1. Ivens D, Hoe A L, Podd T J, Hamilton C R, Taylor I, Royle G T: Assessment of morbidity from complete axillary dissection. Br J Cancer 66(1):136-138, 1992
2. Duff M, Hill A D, McGreal G, Walsh S, McDermott E W, O'Higgins N J: Prospective evaluation of the morbidity of axillary clearance for breast cancer. Br J Surg 88(1):114-117, 2001
3. Weiser M R, Montgomery L L, Susnik B, Tan L K, Borgen P I, Cody H S I: routine intraoperative frozen-section examination of sentinel lymph nodes in breast cancer worthwhile? Ann Surg Oncol 7(9): 651-655, 2000
4. Krishnamurthy S, Meric-Bernstam F, Lucci A, Hwang R F, Kuerer H M, Babiera G, Ames F C, Feig B W, Ross M I, Singletary E, Hunt K K, Bedrosian I A: prospective study comparing touch imprint cytology, frozen section analysis, and rapid cytokeratin immunostain for intraoperative evaluation of axillary sentinel lymph nodes in breast cancer. Cancer 115(7):1555-1562, 2009. https://doi.org/10.1002/cncr.24182.
5. Vanderveen K A, Ramsamooj R, Bold R J A: prospective, blinded trial of touch prep analysis versus frozen section for intraoperative evaluation of sentinel lymph nodes in breast cancer. Ann Surg Oncol 15(7):2006-2011, 2008. https://doi.org/10.1245/s10434-008-9944-8.
6. Pogacnik A, Klopcic U, Grazio-Frković S, Zgajnar J, Hocevar M, Vidergar-Kralj B: The reliability and accuracy of intraoperative imprint cytology of sentinel lymph nodes in breast cancer. Cytopathology 16(2):71-76, 2005
7. Akay C L, Albarracin C, Torstenson T, Bassett R, Mittendorf E A, Yi M, Kuerer H M, Babiera G V, Bedrosian I, Hunt K K, Hwang R F: Factors impacting the accuracy of intra-operative evaluation of sentinel lymph nodes in breast cancer. Breast J 24(1):28-34, 2018. https://doi.org/10.1111/tbj.12829
8. Ballal H, Hunt C, Bharat C, Murray K, Kamyab R, Saunders C: Arm morbidity of axillary dissection with sentinel node biopsy versus delayed axillary dissection. ANZ J Surg, 2018. https://doi.org/10.1111/ans.14382
9. Renaudeau C, Lefebvre-Lacoeuille C, Campion L, Dravet F, Descamps P, Ferron G, Houvenaeghel G, Giard S, Tunon de Lara C, Dupre P F, Fritel X, Ngô C, Verhaeghe J L, Faure C, Mezzadri M, Damey C, Classe J M: Evaluation of sentinel lymph node biopsy after previous breast surgery for breast cancer: GATA study. Breast 28:54-59, 2016. https://doi.org/10.1016/j.breast.2016.04.006.
10. An Y S, Lee D H, Yoon J K, Lee S J, Kim T H, Kang D K, Kim K S, Jung Y S, Yim H: Diagnostic performance of 18F-FDG PET/CT, ultrasonography and MRI. Detection of axillary lymph node metastasis in breast cancer patients. Nuklearmedizin 53(3):89-94, 2014. https://doi.org/10.3413/Nukmed-0605-13-06.
11. Cooper K L, Meng Y, Harnan S, Ward S E, Fitzgerald P, Papaioannou D, Wyld L, Ingram C, Wilkinson I D, Lorenz E: Positron emission tomography (PET) and magnetic resonance imaging (MRI) for the assessment of axillary lymph node metastases in early breast cancer: systematic review and economic evaluation. Health Technol Assess 15(4): iii-iiv, 1-134, 2011. https://doi.org/10.3310/hta15040
12. Hwang S O, Lee S W, Kim H J, Kim W W, Park H Y, Jung J H: The comparative study of ultrasonography, contrast-enhanced MRI, and (18)F-FDG PET/CT for detecting axillary lymph node metastasis in T1 breast cancer. J Breast Cancer 16(3):315-321, 2013. https://doi.org/10.4048/jbc.2013.16.3.315
13. Scaranelo A M, Eiada R, Jacks L M, Kulkarni S R, Crystal P: Accuracy of unenhanced MR imaging in the detection of axillary lymph node metastasis: study of reproducibility and reliability. Radiology 262(2):425-434, 2012. https://doi.org/10.1148/radiol. 11110639.
14. Hieken T J, Trull B C, Boughey J C, Jones K N, Reynolds C A, Shah S S, Glazebrook K N: Preoperative axillary imaging with percutaneous lymph node biopsy is valuable in the contemporary management of patients with breast cancer. Surgery 154(4):831-838, 2013
15. Abe H, Schacht D, Kulkarni K, Shimauchi A, Yamaguchi K, Sennett C A, Jiang Y: Accuracy of axillary lymph node staging in breast cancer patients: an observer-performance study comparison of MRI and ultrasound. Acad Radiol 20(11):1399-1404, 2013. https://doi.org/10.1016/j.acra.2013.08.003
16. LeCun Y, Bengio Y, Hinton G: Deep learning. Nature 521(7553): 436-444, 2015. https://doi.org/10.1038/nature14539.
17. Pieper S, Lorensen B, Schroeder W, et al: The NA-MIC Kit: ITK, VTK, pipelines, grids and 3D slicer as an open platform for the medical image computing community. Proceedings of the 3rd IEEE International Symposium on Biomedical Imaging: From Nano to Macro 1:698-701, 2006.
18. Simonyan K, Zisserman A: Very deep convolutional networks for large-scale image recognition. International Conference on Learning Representations. 2015, p. 1-14
19. Nair V, Hinton G E: Rectified linear units improve restricted Boltzmann machines. https://www.cs.toronto.edu/˜hinton/absps/reluICML.pdf
20. Ioffe S, Szegedy C: “Batch normalization: accelerating deep network training by reducing internal covariate shift.” International Conference on Machine Learning. 2015
21. Srivastava N, Hinton G E, Krizhevsky A, Sutskever I, Salakhutdinov R: Dropout: a simple way to prevent neural net-works from overfitting. J Mach Learn Res 15:1929-1958, 2014
22. Kingma D P, Ba J: Adam: a method for stochastic optimization. arXiv preprint arXiv:1412.6980, 2014
23. He K, Zhang X, Ren S, et al: Delving deep into rectifiers: surpassing human-level performance on ImageNet classification. arXiv: 1502.01852 https://arxiv.org/pdf/1502.01852.pdf.
24. DeSantis C, Ma J, Sauer A G et al.: Breast cancer statistics, 2017, racial disparity in mortality by state. CA Cancer J Clin 67(6):439-448, 2017
25. Pal T, Permuth-Wey J, Betts J A, Krischer J P, Fiorica J, Arango H, LaPolla J, Hoffman M, Martino M A, Wakeley K, Wilbanks G, Nicosia S, Cantor A, Sutphen R: BRCA1 and BRCA2 mutations account for a large proportion of ovarian carcinoma cases. Cancer 104(12):2807-2816, 2005
26. Burke W, Daly M, Garber J, Botkin J, Kahn M J, Lynch P, McTiernan A, Offit K, Perlman J, Petersen G, Thomson E, Varricchio C: Recommendations for follow-up care of individuals with an inherited predisposition to cancer. II. BRCA1 and BRCA2. Cancer genetics studies consortium. JAMA 277(12): 997-1003, 1997
27. Schairer C, Lubin J, Troisi R, Sturgeon S, Brinton L, Hoover R: Menopausal estrogen and estrogen-progestin replacement therapy and breast cancer risk. JAMA 283(4):485-491, 2000
28. Byrne C, Schairer C, Brinton L A, Wolfe J, Parekh N, Salane M, Carter C, Hoover R: Effects of mammographic density and benign breast disease on breast cancer risk (United States). Cancer Causes Control 12(2):103-110, 2001
29. McCormack V A, dos Santos S I: Breast density and parenchymal patterns as markers of breast cancer risk: a meta-analysis. Cancer Epidemiol Biomark Prev 15(6):1159-1169, 2006
30. Boyd N, Martin L, Gunasekara A, Melnichouk O, Maudsley G, Peressotti C, Yaffe M, Minkin S: Mammographic density and breast cancer risk: evaluation of a novel method of measuring breast tissue volumes. Cancer Epidemiol Biomarkers Prev 18(6): 1754-1762, 2009
31. American College of Radiology: Breast imaging reporting and data system (BI-RADS), 5th edition. Reston: American College of Radiology, 2013
32. King V, Brooks J D, Bernstein J L, Reiner A S, Pike M C, Morris E A: Background parenchymal enhancement at breast MR imaging and breast cancer risk. Radiology 260(1):50-60, 2011
33. Dontchos B N, Rahbar H, Partridge S C, Korde L A, Lam D L, Scheel J R, Peacock S, Lehman C D: Are qualitative assessments of background parenchymal enhancement, amount of fibroglandular tissue on MR images, and mammographic density associated with breast cancer risk? Radiology 276(2):371-380, 2015
34. Melsaether A, McDermott M, Gupta D, Pysarenko K, Shaylor S D, Moy L: Inter- and intrareader agreement for categorization of background parenchymal enhancement at baseline and after training. AJR Am J Roentgenol 203(1):209-215, 2014
35. Ha R, Mema E, Guo X, Mango V, Desperito E, Ha J, Wynn R, Zhao B: Quantitative 3D breast magnetic resonance imaging fibroglandular tissue analysis and correlation with qualitative assessments: a feasibility study. Quant Imaging Med Surg 6(2):144 150, 2016
36. Ha R, Mema E, Guo X, Mango V, Desperito E, Ha J, Wynn R, Zhao B: Three-dimensional quantitative validation of breast magnetic resonance imaging background parenchymal enhancement assessments. Curr Probl Diagn Radiol 45(5):297-303, 201
37. Mema E, Mango V, Guo X et al.: Does breast MRI background parenchymal enhancement indicate metabolic activity? Qualitative and 3D quantitative computer imaging analysis. J Magn Reson Imaging 47(3):753-759, 2018
38. Clendenen T V, Zeleniuch-Jacquotte A, Moy L, Pike M C, Rusinek H, Kim S: Comparison of 3-point Dixon imaging and fuzzy C-means clustering methods for breast density measurement. J Magn Reson Imaging 38(2):474-481, 2013
39. Eyal E, Badikhi D, Furman-Haran E, Kelcz F, Kirshenbaum K J, Degani H: Principal component analysis of breast DCE-MRI adjusted with a model-based method. J Magn Reson Imaging 30(5):989-998, 2009
40. LeChun Y, Bengio T, Hinton G: Deep learning. Nature 521:436-444, 2015
41. Ronneberger O, Fischer P, Brox T: U-Net: convolutional networks for biomedical image segmentation. Medical image computing and computer-assisted intervention (MICCAI), springer. LNCS 9351: 234-241, 2015
42. Çiçek O, Abdulkadir A, Lienkamp S et al.: 3D U-Net: learning dense volumetric segmentation from sparse annotation. Medical image computing and computer-assisted intervention (MICCAI), springer. LNCS 9901:424-432, October 2016
43. He K, Zhang X, Ren S et al.: Deep residual learning for image recognition. ArxivOrg [Internet]. 7(3):171-180, 2015. https://doi.org/10.1007/978-3-319-10590-1˜53%5Cn http://arxiv.org/abs/1311.2901%5Cnpapers3://publication/uuid/44feb4b 1-873 a-4443-8baa-1730ecd16291
44. Springenberg J T, Dosovitskiy A, Brox T, et al. Striving for simplicity: the all convolutional net. 2014 Dec. 21 [cited 2017 Jul. 21]; Available from: http://arxiv.org/abs/1412.6806
45. He K, Zhang X, Ren S, et al. “Delving deep into rectifiers: surpassing human-level performance on ImageNet classification,” arXiv: 1502.01852, (2015).
46. Kingma D P, Ba J, Adam: A method for stochastic optimization. arXiv:1412.6980 [cs.LG], December 2014.
47. Gubern-Mérida A, Kallenberg M, Mann R M et al.: Breast segmentation and density estimation in breast MRI: a fully automatic framework. IEEE J Biomed Health Inform 19(1):349-357, 2015
48. Tustison N J, Avants B B, Cook P A, Yuanjie Zheng, Egan A, Yushkevich P A, Gee J C: N4ITK: improved N3 bias correction. IEEE Trans Med Imaging. 29(6):1310-1320, 2010 June
49. Siegel R, Ma J, Zou Z, Jemal A. Cancer Statistics, 2014. CA Cancer J Clin 2014; 64:9-29.
50. Perou C M, Sørlie T, Eisen M B, et al. Molecular portraits of human breast tumours. Nature. 2000 Aug. 17; 406(6797):747-52.
51. Morris E A (2010) Diagnostic breast MR imaging: current status and future directions. Magn Reson Imaging Clin N Am 18:57-74.
52. Liberman L, Morris E A, Dershaw D D, et al. MR imaging of the ipsilateral breast in women with percutaneously proven breast cancer. AJR Am J Roentgenol. 2003 April; 180(4):901-10.
53. Schelfout K, Van Goethem M, Kersschot E, et al. Contrast-enhanced MR imaging of breast lesions and effect on treatment. Eur J Surg Oncol. 2004 June; 30(5):501-7.
54. Sorlie et al 2001]. Sørlie T, Perou C M, Tibshirani R, et al. Gene expression patterns of breast carcinomas distinguish tumor subclasses with clinical implications. Proc Natl Acad Sci USA. 2001 Sep. 11; 98(19):10869-74.
55. Wiechmann L, Sampson M, Stempel M, et al. Presenting features of breast cancer differ by molecular subtype. Ann Surg Oncol. 2009 October; 16(10):2705-10.
56. Morrow M, Waters J, Morris E. MRI for breast cancer screening, diagnosis, and treatment. Lancet. 2011; 378:1804-1811.
57. Goldhirsch 2011. Goldhirsch A, Wood W C, Coates A S, et al. Strategies for subtypes—dealing with the diversity of breast cancer: highlights of the St. Gallen International Expert Consensus on the Primary Therapy of Early Breast Cancer 2011. Ann Oncol. 2011 August; 22(8):1736-47.
58. Metzger-Filho O, Sun Z, Viale G, et al. Patterns of recurrence and outcome according to breast cancer subtypes in lymph node-negative disease: results from international Breast Cancer Study Group Trials VIII and IX. J Clin Oncol. 2013; 31(25): 3083±90.
59. Carey L A, Dees E C, Sawyer L, Gatti L, Moore D T, Collichio F, et al. The triple negative paradox: primary tumor chemosensitivity of breast cancer subtypes. Clin Cancer Res. 2007; 13(8): 2329±34.
60. Kumar V, Gu Y, Basu S, Berglund A, Eschrich S A, Schabath M B, et al. Radiomics: the process and the challenges. Magn Reson Imaging. 2012; 30(9): 1234±48.
61. Kuo M D, Jamshidi N. Behind the Numbers: Decoding Molecular Phenotypes with Radiogenomics—Guiding Principles and Technical Considerations. Radiology 2014 February; 270(2):320-5.
62. Holli-Helenius K, Salminen A, Rinta-Kiikka I, et al. MRI texture analysis in differentiating luminal A and luminal B breast cancer molecular subtypes—a feasibility study. BMC Med Imaging. 2017 Dec. 29; 17(1):69.
63. Chen W, Giger M L, Lan L, Bick U. Computerized interpretation of breast MRI: investigation of enhancement-variance dynamics. Med Phys 2004. 31:1076-108
64. Guo W, Li H, Zhu Y et al, TCGA Breast Phenotype Research Group. Prediction of clinical phenotypes in invasive breast carcinomas from the integration of radiomics and genomics data. J Med Imaging (Bellingham) 2015. 2:041007.
65. Fan et al 2017:] Fan M, Li H, Wang S, et al. Radiomic analysis reveals DCE-MRI features for prediction of molecular subtypes of breast cancer. PLoS One. 2017 Feb. 6; 12(2):e0171683.
66. Bhooshan N, Giger M L, Jansen S A, et al. Cancerous breast lesions on dynamic contrast-enhanced MR images: computerized characterization for image-based prognostic markers. Radiology. 2010 March; 254(3):680-90.
67. Bhooshan et al 2011 Phy Med Biol]. Bhooshan N, Giger M, Edwards D, et al. Computerized three-class classification of MRI-based prognostic markers for breast cancer. Phys Med Biol. 2011 Sep. 21; 56(18):5995-6008.
68. Agner S C, Rosen M A, Englander S et al (2014) Computerized image analysis for identifying triple-negative breast cancers and differentiating them from other molecular subtypes of breast cancer on dynamic contrast-enhanced MR images: a feasibility study. Radiology 272:91-99
69. Mazurowski M A, Zhang J, Grimm L J, et al. Radiogenomic analysis of breast cancer: luminal B molecular subtype is associated with enhancement dynamics at MR imaging. Radiology. 2014 November; 273(2):365-72.
70. Grimm L J, Zhang J, Mazurowski M A. Computational approach to radiogenomics of breast cancer: luminal A and luminal B molecular subtypes are associated with imaging features on routine breast MRI extracted using computer vision algorithms. J Magn Reson Imaging. 2015; 42(4): 902±7.
71. Yamamoto S, Han W, Kim Y, et al. Breast Cancer: Radiogenomic Biomarker Reveals Associations among Dynamic Contrast-enhanced MR Imaging, Long Noncoding RNA, and Metastasis. Radiology. 2015 May; 275(2):384-92.
72. Ashraf et al2014. Ashraf A B, Daye D, Gavenonis S, et al. Identification of intrinsic imaging phenotypes for breast cancer tumors: preliminary associations with gene expression profiles. Radiology. 2014 August; 272(2):374-84.
73. Yamaguchi K, Abe H, Newstread G, et al. Intratumoral heterogeneity of the distribution of kinetic parameters in breast cancer: comparison based on the molecular subtypes of invasive breast cancer. Breast Cancer. 2015; 22(5):496-502.
74. Blaschke E, Abe H. MRI phenotype of breast cancer: kinetic assessment for molecular subtypes. J Magn Reson Imaging. 2015; 42(4): 920-4.
75. LeChun Y, Bengio T, Hinton G. Deep learning. Nature. 2015; 521:436-444.
76. Ha R, Jin B, Mango V, et al. Breast cancer molecular subtype as a predictor of the utility of preoperative MRI. AJR Am J Roentgenol. 2015 June; 204 (6):1354-60.
77. Carey L A, Perou C M, Livasy C A, et al: Race, breast cancer subtypes, and survival in the Carolina Breast Cancer Study. JAMA 295:2492-2502, 2006
78. Nguyen P L, Taghian A G, Katz M S, et al. Breast cancer subtype approximated by estrogen receptor, progesterone receptor, and HER-2 is associated with local and distant recurrence after breast-conserving therapy. J Clin Oncol. 2008 May 10; 26(14):2373-828.
79. LeCun, Yann, Léon Bottou, Yoshua Bengio, et al. “Gradient-based learning applied to document recognition.” Proceedings of the IEEE 86, no. 11 (1998): 2278-2324.
80. He, Kaiming, Xiangyu Zhang, Shaoqing Ren, et al. “Deep residual learning for image recognition.” In Proceedings of the IEEE conference on computer vision and pattern recognition, pp. 770-778. 2016.
81. Nair, Vinod, and Geoffrey E. Hinton. “Rectified linear units improve restricted boltzmann machines.” In Proceedings of the 27th international conference on machine learning (ICML-10), pp. 807-814. 2010.
82. Ioffe, Sergey, and Christian Szegedy. “Batch normalization: Accelerating deep network training by reducing internal covariate shift.” International Conference on Machine Learning. 2015.
83. Srivastava, Nitish, Geoffrey Hinton, Alex Krizhevsky, et al. “Dropout: a simple way to 9 prevent neural networks from overfitting.” The Journal of Machine Learning Research 15, no. 1 (2014): 1929-1958.
84. Kingma, Diederik P., and Jimmy Ba. “Adam: A method for stochastic optimization.” arXiv preprint arXiv:1412.6980 (2014).
85. Nesterov, Yurii. “Gradient methods for minimizing composite objective function.” (2007).
86. Dozat, Timothy. “Incorporating nesterov momentum into adam.” (2016).
87. Glorot, Xavier, and Yoshua Bengio. “Understanding the difficulty of training deep feedforward neural networks.” In Proceedings of the thirteenth international conference on artificial intelligence and statistics, pp. 249-256. 2010.
88. Guiu S, Michiels S, André F, et al. Molecular subclasses of breast cancer: how do we define them? The IMPAKT 2012 Working Group Statement. Ann Oncol. 2012 December; 23(12):2997-3006.
89. Sun C et al2017: Sun C, Shrivastaval A, Singh S, et al. “Revisiting Unreasonable Effectiveness of Data in Deep Learning Era.” arXiv preprint arXIV: 1707.02968 (2017).

1. A non-transitory computer-accessible medium having stored thereon computer-executable instructions for classifying at least one tissue of at least one patient, wherein, when a computer arrangement executes the instructions, the computer arrangement is configured to perform procedures comprising:
receiving at least one image of at least one internal portion of a breast of the at least one patient; and
automatically classifying the at least one tissue of the breast by applying at least one neural network to the at least one image.

2. The computer-accessible medium of claim 1, wherein the at least one tissue includes at least one lymph node.

3. The computer-accessible medium of claim 2, wherein the computer arrangement is further configured to automatically classify the at least one lymph node as a cancerous tissue or a non-cancerous tissue.

4. The computer-accessible medium of claim 1, wherein the computer arrangement is further configured to automatically classify the at least one tissue as a fibroglandular tissue or a background parenchymal enhancement tissue.

5. The computer-accessible medium of claim 1, wherein the computer arrangement is further configured to automatically classify the at least one tissue as a cancer molecular subtype.

6. The computer-accessible medium of claim 1, wherein the at least one image is a magnetic resonance image.

7. The computer-accessible medium of claim 1, wherein the at least one neural network is a convolutional neural network (CNN).

8. The computer-accessible medium of claim 7, wherein the CNN includes a plurality of layers.

9. The computer-accessible medium of claim 8, wherein the layers include (i) a plurality of convolutional layers, (ii) a plurality of rectified linear unit layers, and (iii) a plurality of fully connected layers.

10. The computer-accessible medium of claim 9, wherein at least one of the fully connected layers includes 512 neurons.

11. The computer-accessible medium of claim 8, wherein the layers include (i) a plurality of convolutional layers, (ii) a plurality of residual layers, and (iii) a plurality of linear layers.

12. The computer-accessible medium of claim 7, wherein the CNN includes a collapsing and expanding CNN.

13. The computer-accessible medium of claim 12, wherein (i) an expanding arm of the collapsing and expanding CNN includes a plurality of convolutional filters and a plurality of strided convolutions, and (ii) a collapsing arm of the collapsing and expanding CNN includes a plurality of convolutional transpose filters.

14. The computer-accessible medium of claim 1, wherein the computer arrangement is further configured to determine at least one score based on the at least one image using the at least one neural network.

15. The computer-accessible medium of claim 14, wherein the computer arrangement is further configured to automatically classify the tissue based on the at least one score.

16. The computer-accessible medium of claim 15, wherein the computer arrangement is configured to automatically classify the tissue based on the score being above 0.5.

17. The computer-accessible medium of claim 1, wherein the computer arrangement is further configured to normalize intensity values in the at least one image.

18. The computer-accessible medium of claim 17, wherein the computer arrangement is configured to normalize the intensity values using at least one z score map.

19. A method for classifying at least one tissue of at least one patient, comprising:
receiving at least one image of at least one internal portion of a breast of the at least one patient; and
using a computer hardware arrangement, automatically classifying the at least one tissue of the breast by applying at least one neural network to the at least one image.

20-36. (canceled)

37. A system for classifying at least one tissue of at least one patient, comprising:
a computer hardware arrangement configured to:
receive at least one image of at least one internal portion of a breast of the at least one patient; and
automatically classify the at least one tissue of the breast by applying at least one neural network to the at least one image.

38-54. (canceled)
